(19) United States
(12) Patent Application Publication
(10) Pub. No.: US 2008/0160298 A1
(43) Pub. Date: Jul. 3, 2008

(54) POLYCARBONATE GLAZING SYSTEM AND METHOD FOR MAKING THE SAME

(76) Inventors: Chengtao Li, Novi, MI (US); Keith D. Weiss, Fenton, MI (US)

Correspondence Address: EXATEC;C/O BRINKS HOFER GILSON & LIONE, P. O. BOX 10395, CHICAGO, IL, 60610, US

(21) Appl. No.: 11/964,512

(22) Filed: Dec. 26, 2007

Related U.S. Application Data
(60) Provisional application No. 60/882,309, filed on Dec. 28, 2006.

(51) Int. Cl. B32B 27/36; B32B 33/00; B05D 5/00; B32B 27/00; B32B 27/40

(52) U.S. Cl. 428/337; 428/411.1; 428/421; 428/447; 428/423.1; 428/412; 428/446; 428/698; 428/702; 428/480; 156/300

(57) ABSTRACT

A multifunctional glazing panel for automotive window assembly. The glazing panel includes a plastic film having a functional layer, a base layer of a polymer material, a tie layer between the plastic film and the base layer. An abrasion resistant layer, for protecting the plastic film and base layer from damage caused by abrasion, is provided over the plastic film.

### CROSS REFERENCE TO RELATED APPLICATION

This application claims priority to U.S. Provisional Application 60/882,309 entitled METHOD TO MAKE FUNCTIONAL POLYCARBONATE GLAZING, filed on Dec. 28, 2006, the entirety of which is herein incorporated by reference.

### BACKGROUND OF THE INVENTION

1. Field of the Invention

The preset invention generally relates to polycarbonate glazing systems and methods for making the same.

2. Description of the Known Technology

Polycarbonate is becoming widely accepted as a desirable replacement for metallic and glass articles in the automotive industry. Due to its superior strength, optical clarity, greater freedom in vehicle styling, and excellent thermal properties, polycarbonate is used in the manufacture of automotive window systems with specific functional features. The use of a polymer material in making multilayer articles to exhibit better structural integrity and desirable functional properties has already been known in the art for quite some time. However, with the ever-increasing advance in polycarbonate technology, there now exists a huge demand for complex three-dimensional parts with multifunctional features, in addition to complex decoration.

It remains of interest to therefore develop an automotive glazing assembly with functional layers such as weathering, solar control, defrosting, defogging, antenna, printed decoration, photochromatic light control, electrochromic and electroluminescent. It is further of interest to prepare automotive glazing assembly using a low cost and fast alternative to injection molding.

### BRIEF SUMMARY OF THE INVENTION

In one aspect, the present invention relates to multifunctional glazing systems and method for making the same. More particularly, it relates to a multifunctional glazing assembly suitable for use in automobiles. In one embodiment, a glazing assembly includes a plastic film layer having a functional layer, a base layer of a polymer material, a tie layer between the plastic film and the base layer, and an abrasion resistant layer. The tie layer is compatible with the base layer and has good adhesive properties. Essentially, the tie layer will adhere the plastic film layer to the base layer.

In another aspect, the present invention provides a method of making a multifunctional glazing assembly that involves a vacuum thermoforming process instead of a more common injection molding process, thereby reducing issues associated with high cost and low volume production.

Other objects, features and advantages of the present invention will become more apparent upon considering the following detailed description, examples, and appended claims.

### BRIEF DESCRIPTION OF THE DRAWINGS

FIG. 1 illustrates a diagrammatic representation of a section through a glazing panel embodying the principles of the present invention;

FIG. 2 illustrates a system for making the glazing panel of FIG. 1;

FIG. 3 illustrates another view of the system of FIG. 2; and

FIG. 4 illustrates a close up view of the glazing panel made by the system of FIG. 2.

### DETAILED DESCRIPTION OF THE INVENTION

The present invention relates to an automotive glazing assembly, typically made from polycarbonate laminates, that provides ballistic, bomb blast and forced entry protection. Constructed from polycarbonate sheet layers and bonded with adhesive interlayers, these glass-free laminates offer extremely high impact resistance and absorb impact energy without spalling. They also provide significant weight savings over conventional glazing. Polycarbonate laminates are protected against abrasion, chemicals and UV light by coating systems, such as the Exatec 900/500 coating of Exatec LLC, of Wixom, Mich.

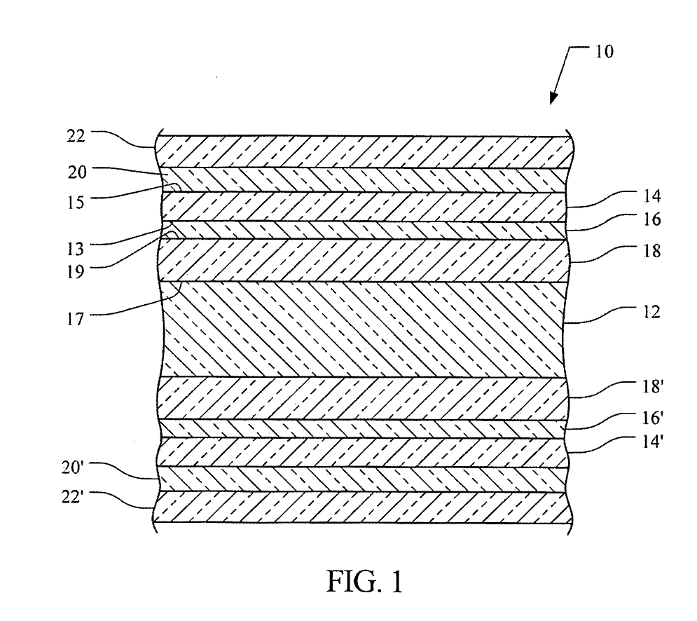

Referring to FIG. 1, a diagrammatic representation of a section through a glazing assembly 10 embodying the principles of the present invention is shown. It should be understood that this diagrammatic representation of the glazing assembly 10 is not drawn to scale, so as to better show the elements of the glazing assembly 10. The glazing assembly 10 includes a base layer 12, at least one plastic film layer 14, at least one functional layer 16, and a tie layer 18. The tie layer 18 is located between the base layer 12 and the plastic film layer 14.

The plastic film layer 14 is preferably made of a material such as polycarbonate, polymethylmethyacrylate, polyester, a polycarbonate/acrylonitrile butadiene styrene blend, or a polycarbonate/polyester blend. Also preferably, the plastic film 14 is an extruded, co-extruded, blown or cast polycarbonate film. The plastic film layer 14 has an inner surface 13 (facing the base layer 12) and an outer surface 15 (facing away from the base layer 12). One or both of the inner and outer surfaces 13, 15 of the plastic film layer 14 may be provided, coated or printed with the functional layer 16. As illustrated in FIG. 1, only the inner surface 13 of the plastic film layer 14 is provided with the functional layer 16.

The functional layer 16 may have any one of a variety of functionalities, including, but not limited to, one or more of weathering, solar control, defrosting, defogging, antenna, printed decoration, photochromic light control, electrochromic and electroluminescent layers. If provided on the inner surface 13 of the plastic film 14, electroluminescent, fluorescent or phosphorescent layers may be the more preferred as the functional layers. If, however, the functional layer 16 is provided on the outer surface 15 of the plastic film layer 1, defroster, antenna, blackout/fadeout, or highly weatherable layers are generally more preferred.

The functional layer 16 is provided with a suitable thickness to provide sufficient functional properties to the glazing assembly 10. Typically, the thickness of the plastic film layer 14 with the functional layer 16 is in a range of about 0.05 mm to about 1 mm, wherein the functional layer is applied onto the surface of the plastic film 14 by any suitable application method.

As mentioned above, glazing assembly 10 further includes a tie layer 18, which is located between the functional layer 16 and the base layer 12. The tie layer 18 can be of a single layer or of a multilayer form, with each of the multilayers being of a different material for selective adhesion to either of the layers base and functional film. Typically, the tie layer 18 must be transparent and crystal clear (light transmissity (LT)>90%), compatible with the base layer 12 and should exhibit excellent heat resistance to all the post forming operations, such as coating. The tie layer 18, although thin, can determine the overall performance of the end product. The tie layer 18 may contain any polymeric material that enhances the adhesion between the relevant layers of the glazing. Preferably, the tie layer 18 is an adhesive layer such as thermoplastic polyurethane (TPU). TPU has exceptional ultraviolet stability, excellent transparency, good low temperature flexibility, excellent adhesive properties and wear performance, high peel strength, excellent hydrolysis and microbial resistance. Examples of tie layers that are suitable candidates for providing adhesion between the base layer and the functional layer and film include an aliphatic polyether-based thermoplastic polyurethane (e.g., Krystalgran PE193, PE399); a polyester/polyether-based thermoplastic polyurethane capable of injection molding (e.g., Krystalgran PE 409); an anionic aliphatic polyester-based polyurethane dispersion (e.g., Impranil DLS); an anionic aliphatic polyester/polyether polyurethane dispersion (e.g., Impranil DLV Dispersion), an aqueous polyurethane dispersion (e.g., Dispercoll U42), a linear aliphatic polyester urethane based on hexamethylene diisocyanate in aqueous dispersion, (e.g., Dispercoll U KA 8758), and other polyester acrylic and polyamide adhesives and the like.

In a preferred embodiment, the tie layer 18, such as a TPU adhesive film, is placed on the interior side of the functional layer 18 and has a thickness in the range of between about 0.05 mm and about 2.5 mm.

As seen in FIG. 1, the base layer 12 is affixed to a bottom side of the tie layer 18. In a preferred embodiment, the base layer 12 is made of a material such as polycarbonate, polymethylmethyacrylate, polyester, a polycarbonate/acrylonitrile butadiene styrene blend, or a polycarbonate/polyester blend. The base layer 12 may be either formed from an extruded sheet or molded into a plaque or panel. More particularly, the base layer 12 defines a substrate and may have a configuration appropriate for the window opening of an automobile. The thickness of the base layer 12 is preferably in a range of about 3 mm to 6 mm.

A weathering layer 20 is located over the plastic film layer 14, on a side opposite of the base layer 12. The weathering layer 50 is preferably of a material selected from the group of acrylic-, ionomer-, fluoro-, urethane-, siloxane-based polymers, copolymers or blends thereof.

The glazing assembly 10 may also include an abrasion resistant layer 22 over the weathering layer 20 to provide abrasion or scratch resistance. The abrasion resistant layer 22 is preferably a material capable of resisting abrasion, which is usually caused by external exposure of the glazing assembly 10. Typically, the abrasion resistant layer 22 is a plasma polymerized and oxidized organosilicon material containing silicon, hydrogen, carbon and oxygen. In preferred embodiments, the abrasion resistant layer 22 comprises a material selected from the group of aluminium oxide, barium fluoride, boron nitride, hafnium oxide, lanthanum fluoride, magnesium oxide, scandium oxide, silicon monoxide, silicon dioxide, silicon nitride, silicon oxy-nitride, silicon oxy-carbide, hydrogenated silicon oxy-carbide, silicon carbide, tantalum oxide, titanium oxide, tin oxide, yttrium oxide, zinc oxide, zinc selenide, zinc sulphide, zirconium oxide, and zirconium titanate.

One or more layers may be optionally provided on the opposing side (the interior side in the case of a glazing assembly 10 for a motor vehicle) of the base layer 12. Still referring to FIG. 1, the glazing assembly 10 may be provided with one or more optional layers. Proceeding interiorly from the base layer 12, these may include a tie layer 18′, a function layer 16′ (with the same or a different functionality from the functional layer 16 on the exterior side of the base layer 12), a film layer 14′, a weathering layer 20′ and an abrasion resistance layer 22′. Similar reference numerals have been utilized to indicate that the construction of the optional interior layers is or may be substantially the same as the corresponding layer on the exterior of the base layer 12. While illustrated as having an interior side with the same layers as on the exterior side of the base layer 12, it should be understood that the glazing assembly 10 could be provided without one or more of these optional layers.

In another aspect, the present invention provides a method for manufacturing the glazing assembly 10. In a broad sense, the method comprises the steps of (a) providing the plastic film layer 14 having a functional layer 16 fixedly attached thereto, (b) providing a tie layer 18, (c) providing a base layer 12, and (d) adhering the plastic film layer 14 to the base layer 12 using the tie layer 18 as an adherent. Thereafter, the glazing assembly 12 can be formed into the shape of a window. Finally, a weathering layer 20 and an abrasion resistant layer 22 are deposited onto a surface of the plastic film layer 14.

In forming the plastic film layer 14 and functional layer 16, the functional layer 16 may be formed via co-extrusion with the plastic film layer 14, although other methods of providing the functional layer 16 on the plastic film layer 14 are acceptable. Such other methods include, but are not limited to, flow coating, dip coating, roll coating, extrusion coating, printing, adhesive binding, vacuum deposition, and sputtering.

In one particular embodiment, the functional layer 16 may be applied onto the surface of the plastic film layer 14 via screen printing. Further methods of forming the functional layer 16 on the film include, but are not limited to, pad printing, membrane image transfer printing, digital printing, robotic dispensing, solvent casting, mask/spray, ink-jet printing, and the like. When the weathering layer 20 is applied to the plastic film layer 14, the weathering layer 20 may be applied using spray coating, flow coating, dip coating, curtain coating, extrusion coating, in-mold coating, roller coating or another known method. The functional layer 16 may have as its functionality, antenna, photochromatic, electrochromic or electroluminescent functionalities.

To form the glazing assembly 10, the plastic film layer 14 and functional layer 16 are subsequently laminated to the base layer 12 with a tie layer 18. (Alternatively, the plastic film layer 14 and functional layer 16 may be laminated without any adhesive or tie layer 18 between the base layer 12 and the functional layer 16.) Adhesion between the tie layer 18, the plastic film layer 17, functional layer 16 and base layer 12 is preferably accomplished using a method such as extrusion, co-extrusion, lamination, and extrusion-lamination.

The glazing assembly 10 is then transformed or shaped into a design shape by vacuum thermoforming, pressure assisted thermoforming, drape forming, twin-sheet forming, or cold forming. In a preferred embodiment, forming the design shape is best achieved by vacuum thermoforming. All thermoforming techniques have the advantage that they form the film over the tool, rather than stamping it into the required shape. This may reduce of occurrence of any potential image distortion, as well as maintain the strength of the material on which any image is printed.

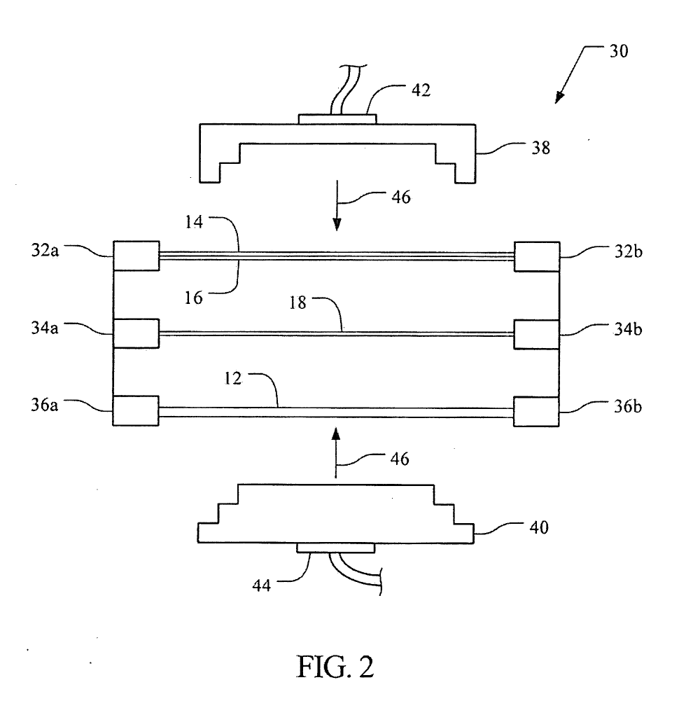

Referring to FIG. 2, a system 30 for making the glazing assembly 10 of FIG. 1 is shown. The system 30 includes a first pair of clamp frames 32a, 32b, a second pair of clamp frames 34a, 34b, and a third pair of clamp frames 36a, 36b. The first pair of clamp frames 32a, 32b holds the plastic film layer 14 and the functional layer 16. The second pair of clamp frames 34a, 34b holds the tie layer 18. Finally, the third pair of clamp frames 36a, 36b holds the base layer 12.

In order to manufacture the glazing assembly 10 via a vacuum thermoforming process, the system 30 further includes a top mold 38 and a bottom mold 40. These molds can be shaped in variety of different shapes, depending on the application. In a preferred application, the molds are shaped for the production of automobile windows,

As it is well known in the art of vacuum thermoforming, the molds 38, 40 are capable of being heated and include vacuum systems 42, 44. As it is well understood in the art, the molds 38, 40 are heated and then are moved towards each other as indicated by arrows 46. As the molds 38, 40 move towards each other, the base layer 12, tie layer 18, functional layer 16, and plastic film layer 14 are pressed between the molds 38, 40. During this process, the vacuum systems 42, 44, apply a vacuum to assist in the forming of the glazing assembly 10 to the shape defined by the molds 38, 40. Essentially, the vacuum system 42, 44 draw the air trapped between the plastic film layer 14 and the top mold 38 and the base layer 12 and the bottom mold 40. By so doing, the surface of the plastic film layer 14 and the base layer 12 is generally smooth and does not have any imperfections due to trapped gasses.

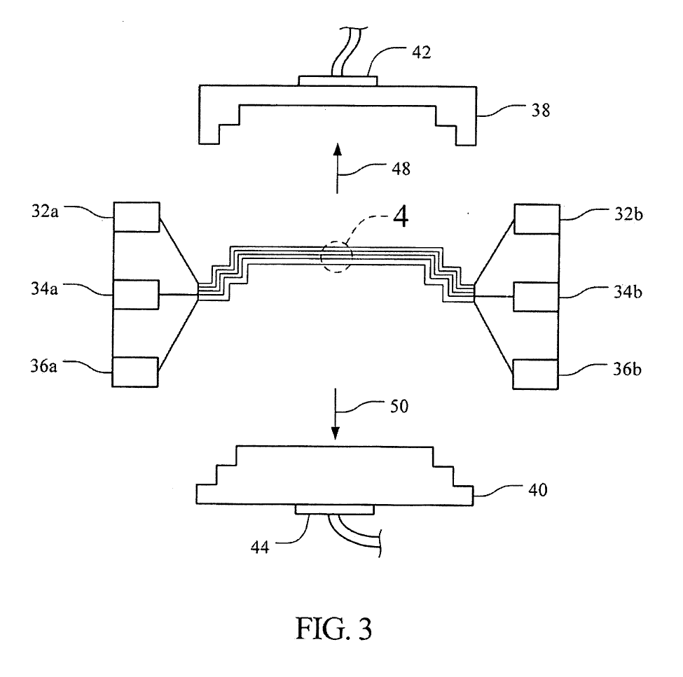

As shown in FIG. 3, once the molds 38, 40 have pressed the plastic film layer 14, functional layer 16, tie layer 18, and base layer 12 together, the molds 38, 40 are then moved away from each other as indicated by arrows 48 and 50.

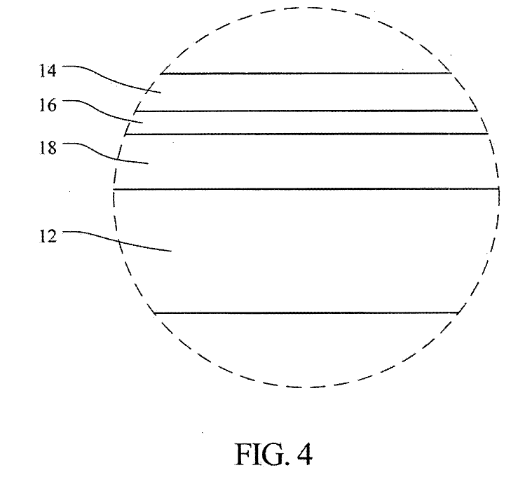

Referring to FIG. 4, an enlarged view of a portion of the glazing assembly 10 is shown. Here, it can be seen that the base layer 12, tie layer 18, function layer 16, and plastic film layer 14 are coupled together and are now ready to receive the weathering layer 20 and abrasion layer 22 shown in FIG. 1.

Referring to FIG. 1, for complex three dimensional (3-D) shapes, pressure assisted thermoforming may be required to achieve good definition and extreme shape. Alternatively, the tie layer 18, along with the base layer 12, the plastic film layer 14 and functional layer, are subjected together into the thermoforming machine such that both adhesive bonding and forming into the 3-D shape occurs simultaneously. However, in cases where the active temperature of the tie layer 18 is lower than the forming temperature, it is required that the plastic film base layer and base layer 12 be formed first, followed by inserting the tie layer between the base layer 12 and the plastic film layer 14 and functional layer 16 positioned in same forming tool, but now at a lower temperature. In the present method, the forming operation is typically carried out using matched-metal type tooling, in which the tool may be either a male or a female die or mold. In a preferred embodiment, both the male and female molds are used for thermoforming such that they match each other. The base layer 12, the plastic film layer 14 and functional layer 16 may be held horizontally in a rotary or in-line shuttle thermoforming machine, as is generally known in the field of thermoforming. After heating, the layers in upper and lower molds soften and are simultaneously vacuum drawn into the male and female molds. The molds are subsequently brought together, with the tie layer therebetween, and the heated layers are compressed and bonded/welded together into a single glazing assembly.

The formed glazing assembly 10 is further coated with an over layer that adds additional or enhanced functionality such as improved abrasion resistance. The over layer is typically an abrasion resistant layer that is deposited using a method selected as one of plasma-enhanced chemical vapor deposition (PECVD), expanding thermal plasma PECVD, plasma polymerization, photochemical vapor deposition, ion beam deposition, ion plating deposition, cathodic arc deposition, sputtering, evaporation, hollow-cathode activated deposition, magnetron activated deposition, activated reactive evaporation, thermal chemical vapor deposition, or a sol-gel coating process.

The glazing assembly 10 can have more layers depending on the thickness and safety requirement. In a particular embodiment, the combined thickness of the glazing assembly 10 is in a range of about 2 mm-10 mm thick. The resulting system can be used for automotive glazing, aircraft glazing, automotive headlamps and taillights, and similar applications.

As a person skilled in the art will readily appreciate, the above description is meant as an illustration of implementation of the principles this invention. This description is not intended to limit the scope or application of this invention in that the invention is susceptible to modification, variation and change, without departing from spirit of this invention, as defined in the following claims.

1. A glazing assembly suitable for use in automobile, the glazing assembly comprising:
a base layer having a first side and a second side;
a abrasion resistant layer located over the first side of the base layer;
a function layer located between the first side of the base layer and the abrasion resistant layer;
a tie layer located between the function layer and the base layer, whereby the tie layer fixedly attaches the functional layer to the base layer;
a plastic film layer located between the functional layer and the abrasion resistant layer;
wherein the abrasion resistant layer protects the plastic film layer and the first side of the base layer from damage caused by abrasion; and
a weathering layer applied to the plastic film layer, the weathering layer being located between the plastic film layer and the abrasion layer.

2. The glazing assembly according to claim 1, wherein the functional layer is one selected from the group of a weathering, solar control, defrosting, defogging, antenna, printed decoration, photochromic light control, electrochromic and electroluminescent layer.

3. The glazing assembly according to claim 1, wherein the weathering layer is of a material selected from the group of acrylic-, ionomer-, fluoro-, urethane-, siloxane-based polymers, or copolymers thereof.

4. The glazing assembly according to claim 1, wherein the plastic film layer is of a material selected from the group of polycarbonate, polymethylmethyacrylate, polyester, thermoplastic polyurethane, a polycarbonate/acrylonitrile butadiene styrene blend, and a polycarbonate/polyester blend.

5. The glazing assembly according to claim 1, wherein the tie layer comprises a material selected from the group of an aliphatic polyether-based thermoplastic polyurethane; a polyester/polyether-based thermoplastic polyurethane; an anionic aliphatic polyester-based polyurethane dispersion; an anionic aliphatic polyester/polyether polyurethane dispersion, an aqueous polyurethane dispersion, polyamide-type adhesives, and polyester acrylic adhesives.

6. The glazing assembly according to claim 1, wherein the base layer is of a material selected from the group of polycarbonate, polymethylmethyacrylate, polyester, a thermoplastic polyurethane, a polycarbonate/acrylonitrile butadiene styrene blend, and a polycarbonate/polyester blend.

7. The glazing assembly according to claim 1, wherein the abrasion resistant layer is a plasma polymerized and organosilicon material comprising silicon, hydrogen, carbon and oxygen.

8. The glazing assembly according to claim 7, wherein the abrasion resistant layer comprises a material selected from the group of aluminium oxide, barium fluoride, boron nitride, hafnium oxide, lanthanum fluoride, magnesium oxide, scandium oxide, silicon monoxide, silicon dioxide, silicon nitride, silicon oxy-nitride, silicon oxy-carbide, hydrogenated silicon oxy-carbide, silicon carbide, tantalum oxide, titanium oxide, tin oxide, yttrium oxide, zinc oxide, zinc selenide, zinc sulphide, zirconium oxide, and zirconium titanate.

9. The glazing assembly according to claim 1, wherein the base layer has a thickness in a range of about 2-10 mm.

10. A method of making a glazing assembly, the method comprising:
providing a plastic film having a functional layer;
providing a tie layer having a top side and a bottom side;
providing a base layer;
adhering the plastic film having the functional layer to the top side of the tie layer;
adhering the bottom side of the tie layer to the base layer, thereby making a plastic panel;
forming the plastic panel into the shape of a window;
depositing an abrasion resistant layer onto the surface of the plastic panel; and
applying a weathering layer to at least one surface of the plastic panel.

11. The method according to claim 10, wherein the weathering layer is applied using a method selected as one from the group of spray coating, flow coating, dip coating, curtain coating, extrusion coating, in-mold coating and roller coating.

12. The method according to claim 10, wherein the plastic panel is made using a method being one selected from the group of vacuum thermoforming, pressure assisted thermoforming, drape forming, twin-sheet forming, and cold forming.

13. The method according to claim 10, wherein the steps of adhering the tie layer to at least one of the plastic film and base layer is accomplished using a method being one selected from the group of extrusion, co-extrusion, lamination, in-mold lamination, and extrusion-lamination.

14. The method according to claim 10, wherein the step of depositing an abrasion resistant layer is deposited using a method selected as one of plasma-enhanced chemical vapor deposition (PECVD), expanding thermal plasma PECVD, plasma polymerization, photochemical vapor deposition, ion beam deposition, ion plating deposition, cathodic arc deposition, sputtering, evaporation, hollow-cathode activated deposition, magnetron activated deposition, activated reactive evaporation, thermal chemical vapor deposition, and a sol-gel coating process.
